(19) United States
(12) Patent Application Publication
(10) Pub. No.: US 2025/0028083 A1
(43) Pub. Date: Jan. 23, 2025

(54) ANTIREFLECTION FILM-ATTACHED TRANSPARENT SUBSTRATE AND IMAGE DISPLAY DEVICE

(71) Applicant: AGC Inc., Tokyo (JP)

(72) Inventors: Hideaki TAKAHOSHI, Tokyo (JP); Yasuhisa NISHIKAWA, Tokyo (JP)

(73) Assignee: AGC Inc., Tokyo (JP)

(21) Appl. No.: 18/908,069

(22) Filed: Oct. 7, 2024

Related U.S. Application Data
(63) Continuation of application No. PCT/JP2023/014150, filed on Apr. 5, 2023.

(30) Foreign Application Priority Data
Apr. 8, 2022 (JP) 2022-064751
Apr. 8, 2022 (JP) 2022-064752
Jul. 13, 2022 (JP) 2022-112709
Nov. 4, 2022 (JP) 2022-177400

(51) Int. Cl. G02B 1/115; C03C 17/34; C03C 17/42; C08J 7/06; G02B 1/18; G02F 1/1333; G09F 9/30

(52) U.S. Cl. CPC G02B 1/115; C03C 17/3417; C03C 17/3482; C03C 17/42; C08J 7/06; G02B 1/18; G09F 9/30; C03C 2217/734; C03C 2217/76; C03C 2218/154; C08J 2301/12; G02F 1/1333

(57) ABSTRACT

An anti-reflective film-attached transparent substrate includes a transparent substrate and an anti-reflective film. The anti-reflective film has a laminated structure in which at least two layers having different refractive indices are laminated, at least one layer is mainly formed of a Si oxide, at least another layer is a mixed oxide layer mainly formed of a mixed oxide containing Mo and Nb, the mixed oxide layer contains an oxide of at least one high hardness metal element selected from the group consisting of W, Cr, Mn, Ni, Zr, Ta, and Be, a proportion of Mo to a total of Mo and Nb in the mixed oxide layer is 60 at % or less, and a proportion of a total of the high hardness metal element to a total of metal elements in the mixed oxide layer is 12 at % or more.

### CROSS-REFERENCE TO RELATED APPLICATIONS

This is a bypass continuation of International Application No. PCT/JP2023/014150 filed on Apr. 5, 2023, and claims priority from Japanese Patent Application No. 2022-177400 filed on Nov. 4, 2022, Japanese Patent Application No. 2022-064751 filed on Apr. 8, 2022, Japanese Patent Application No. 2022-064752 filed on Apr. 8, 2022, and Japanese Patent Application No. 2022-112709 filed on Jul. 13, 2022, the entire content of which is incorporated herein by reference.

### TECHNICAL FIELD

The present invention relates to an anti-reflective film-attached transparent substrate and an image display device including the same.

### BACKGROUND ART

In recent years, a method of installing a transparent substrate such as a cover glass on a front surface of an image display device such as a liquid crystal display (LCD) has been used from the viewpoint of aesthetic appearance. In order to prevent glare from an external light on such a transparent substrate, a transparent substrate provided with an anti-reflective film (hereinafter, also referred to as an anti-reflective film-attached transparent substrate) is known. For example, Patent Literature 1 discloses an anti-reflective film-attached transparent substrate, which has a light absorption ability and an insulating property and has no yellowish transmitted light.

### CITATION LIST

### Patent Literature

Patent Literature 1: JP2018-115105A

### SUMMARY OF INVENTION

### Technical Problem

The anti-reflective film-attached transparent substrate is, for example, arranged on the surface of a display or the like, and is therefore likely to be touched by people's hands or the like relatively frequently. In order to prevent scratches, wear, or the like, it is necessary to increase the strength of the anti-reflective film.

Therefore, an object of the present invention is to provide an anti-reflective film-attached transparent substrate including an anti-reflective film, which is excellent in strength and has optical absorption.

### Solution to Problem

The inventors of the present invention have found that, when the anti-reflective film includes a mixed oxide layer having a specific composition, the strength of the anti-reflective film having optical absorption can be increased. Thus, the present invention has been completed.

That is, the present invention relates to the following 1 to 11.
1. An anti-reflective film-attached transparent substrate including:
a transparent substrate having two main surfaces; and
an anti-reflective film on one main surface of the transparent substrate, in which
the anti-reflective film has a laminated structure in which at least two layers having different refractive indices are laminated,
at least one layer among layers in the laminated structure is mainly formed of a Si oxide,
at least another layer among the layers in the laminated structure is a mixed oxide layer mainly formed of a mixed oxide containing Mo and Nb,
the mixed oxide layer contains an oxide of at least one high hardness metal element selected from the group consisting of W, Cr, Mn, Ni, Zr, Ta, and Be,
a proportion of Mo to a total of Mo and Nb in the mixed oxide layer is 60 at % or less, and
a proportion of a total of the high hardness metal element to a total of metal elements in the mixed oxide layer is 12 at % or more.
2. The anti-reflective film-attached transparent substrate according to the above 1, having a luminous transmittance (Y) of 40% to 90%.
3. The anti-reflective film-attached transparent substrate according to the above 1, having a luminous transmittance (Y) of 40% or more and 60% or less and b* of a transmission color under a D65 light source of 9 or less.
4. The anti-reflective film-attached transparent substrate according to the above 1, having a luminous transmittance (Y) of more than 60% and 90% or less and b* of a transmission color under a D65 light source of 6 or less.
5. The anti-reflective film-attached transparent substrate according to the above 1, in which an indentation hardness on the main surface having the anti-reflective film is 5.6 GPa or more.
6. The anti-reflective film-attached transparent substrate according to the above 1, in which an indentation elastic modulus on the main surface having the anti-reflective film is 75 GPa or more.
7. The anti-reflective film-attached transparent substrate according to the above 1, in which a luminous reflectance (SCI Y) on the main surface having the anti-reflective film is 0.8% or less.
8. The anti-reflective film-attached transparent substrate according to the above 1, in which the anti-reflective film has a thickness of 250 nm or less.
9. The anti-reflective film-attached transparent substrate according to the above 1, in which the number of the layers constituting the laminated structure is 8 or less.
10. The anti-reflective film-attached transparent substrate according to the above 1, including a barrier layer between the transparent substrate and the anti-reflective film, in which the barrier layer includes a layer mainly formed of at least one of SiNₓ and SiOₓ.
11. An image display device including the anti-reflective film-attached transparent substrate according to any one of the above 1 to 10.

### Advantageous Effects of Invention

According to the present invention, it is possible to provide an anti-reflective film-attached transparent substrate including an anti-reflective film, which is excellent in strength and has optical absorption, and an image display device including the same.

### BRIEF DESCRIPTION OF DRAWINGS

FIG. 1s a cross-sectional view schematically showing a configuration example of an anti-reflective film-attached transparent substrate.

### DESCRIPTION OF EMBODIMENTS

Hereinafter, the present invention is described in detail, but the present invention is not limited to the following embodiments, and can be freely modified and implemented without departing from the gist of the present invention. In addition, “to” indicating a numerical range is used to include numerical values written before and after it as a lower limit value and an upper limit value.

Note that, in the present description, “another layer, film, or the like being provided on a main surface of a substrate such as a transparent substrate, on a film such as an anti-reflective film, or between layers” is not limited to an embodiment in which the another layer, film, or the like is provided in contact with the main surface, layer, or film, but may be an embodiment in which the layer, film, or the like is provided in an upward direction. For example, “including an anti-reflective film on a main surface of a transparent substrate” means that the anti-reflective film is provided in contact with the main surface of the transparent substrate, or any other layer, film, or the like may be provided between the transparent substrate and the anti-reflective film.

An anti-reflective film-attached transparent substrate according to an embodiment of the present invention is an anti-reflective film-attached transparent substrate including: a transparent substrate having two main surfaces; and an anti-reflective film on one main surface of the transparent substrate, in which the anti-reflective film has a laminated structure in which at least two layers having different refractive indices are laminated, at least one layer among layers in the laminated structure is mainly formed of a Si oxide, at least another layer among the layers in the laminated structure is a mixed oxide layer mainly formed of a mixed oxide containing Mo and Nb, the mixed oxide layer contains an oxide of at least one high hardness metal element selected from the group consisting of W, Cr, Mn, Ni, Zr, Ta, and Be, a proportion of Mo to a total of Mo and Nb in the mixed oxide layer is 60 at % or less, and a proportion of a total of the high hardness metal element to a total of metal elements in the mixed oxide layer is 12 at % or more.

### (Anti-Reflective Film-Attached Transparent Substrate)

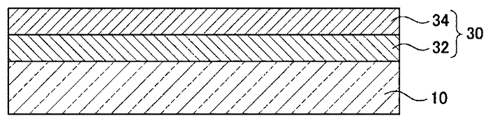

FIG. 1s a cross-sectional view schematically showing a configuration example of an anti-reflective film-attached transparent substrate according to the embodiment of the present invention. An anti-reflective film-attached transparent substrate 1 shown in FIG. includes a transparent substrate 10 having two main surfaces, and an anti-reflective film 30 on one main surface of the transparent substrate 10. The anti-reflective film 30 is a multilayer film having a laminated structure in which at least two layers having different refractive indices are laminated. When a first dielectric layer 32 and a second dielectric layer 34 having different refractive indices are laminated in the anti-reflective film, light reflection can be prevented. For example, in FIGURE, the first dielectric layer 32 is a high refractive index layer and the second dielectric layer 34 is a low refractive index layer.

### (Anti-Reflective Film)

In the present embodiment, at least one layer among the layers constituting the anti-reflective film includes a mixed oxide layer, which is mainly formed of a mixed oxide containing Mo and Nb, which contains an oxide of at least one high hardness metal element selected from the group consisting of W, Cr, Mn, Ni, Zr, Ta, and Be, and in which a proportion of Mo to a total of Mo and Nb in the mixed oxide layer is 60 at % or less, and a proportion of a total of the high hardness metal element to a total of metal elements in the mixed oxide layer is 12 at % or more. The inventors of the present invention have experimentally found that, when the anti-reflective film includes a mixed oxide layer having such a specific composition (hereinafter, also referred to as a “specific mixed oxide layer”), the strength of the anti-reflective film can be increased. Thus, the present invention has been completed.

The reason why the strength of the anti-reflective film is increased by including such a specific mixed oxide layer is thought to be that by mixing the mixed oxide layer with elements for forming high hardness and stable metals or metal oxides, the hardness is increased. From such a viewpoint, the above high hardness metal element can be used in the mixed oxide layer. The mechanism by which adding these elements increases the hardness is thought to be that, for example, by mixing elements having different atom sizes, a strain is induced and the movement of dislocations is hindered, thereby increasing the hardness. In addition, it is thought that the proportion of the elements having different atom sizes may also have an influence on strain.

In addition, the anti-reflective film is also required to have high environmental resistance. That is, the anti-reflective film is required to be resistant to a change in optical properties and to have excellent optical stability even in high temperature or humid heat environments. When the anti-reflective film-attached transparent substrate according to the embodiment of the present invention includes an anti-reflective film including the above specific mixed oxide layer, the optical stability is also excellent. The reason for this is thought to be that the stability is improved by containing a specific proportion of a specific high melting point metal.

The specific mixed oxide layer is a mixed oxide layer mainly formed of a mixed oxide containing Mo and Nb. Here, the mixed oxide layer being “mainly formed of a mixed oxide containing Mo and Nb” means that, among metal elements constituting the mixed oxide layer, the proportion of Mo and Nb is the largest in terms of atomic number compared to other contained components. For example, the proportion of Mo and Nb in the metal elements constituting the mixed oxide layer is preferably 60 at % or more, and more preferably 65 at % or more.

When the anti-reflective film includes a mixed oxide layer mainly formed of a mixed oxide containing Mo and Nb, an anti-reflective film having an appropriate light absorption ability can be obtained. Accordingly, in the case where the anti-reflective film-attached transparent substrate is used as a cover glass of an image display device, the light reflection can be prevented. In addition, a bright contrast of the image display device is improved.

The specific mixed oxide layer contains an oxide of at least one high hardness metal element selected from the group consisting of W, Cr, Mn, Ni, Zr, Ta, and Be. That is, the specific mixed oxide layer is a mixed oxide layer containing Mo, Nb, and a high hardness metal element. In the present embodiment, it is thought that, when the mixed oxide layer mainly formed of a mixed oxide containing Mo and Nb contains an oxide of the high hardness metal element, and the proportion of the total of the high hardness metal element to the total of the metal elements in the mixed oxide layer is a predetermined proportion or more, an increase in strength and an improvement in optical stability of the anti-reflective film are facilitated.

As the high hardness metal element, W or Cr is preferably contained, and W is more preferably contained, from the viewpoints of oxide stability, ease of mixing, or the like. As the high hardness metal element, one kind of element may be included alone, or plural kinds may be included.

The proportion of the total of the high hardness metal element to the total of the metal elements in the mixed oxide layer is 12 at % or more, and preferably 15 at % or more, from the viewpoint of increasing the strength and improving the optical stability. On the other hand, the proportion of the total of the high hardness metal element is preferably 49 at % or less, and more preferably 45 at % or less, from the viewpoint of maintaining the optical properties.

In the specific mixed oxide layer, the proportion of Mo to the total of Mo and Nb is 60 at % or less. As described above, in the present embodiment, it is thought that, when the mixed oxide layer contains the high hardness metal element in a certain amount or more, the strength of the anti-reflective film is increased. On the other hand, it is thought that, due to a difference in oxidation stability for respective kinds of metal elements, the ratio of metal elements in the mixed oxide layer also contributes to the physical properties of the film. Therefore, in the present embodiment, the proportion of Mo to the total of Mo and Nb is 60 at % or less, and preferably 55 at % or less, from the viewpoint of increasing the strength and improving the optical stability of the anti-reflective film. On the other hand, the proportion of Mo to the total of Mo and Nb is preferably 30 at % or more, and more preferably 35 at % or more, from the viewpoint of improving visibility.

A proportion of a total of Mo and Nb to the total of the metal elements in the specific mixed oxide layer is preferably 60 at % or more, and more preferably 65 at % or more, from the viewpoint of obtaining a layer mainly formed of a mixed oxide containing Mo and Nb. On the other hand, the proportion of the total of Mo and Nb to the total of the metal elements is less than 88 at %, preferably 80 at % or less, and more preferably 75 at % or less, from the viewpoint of sufficiently exhibiting the effect of the high hardness metal element.

The proportion of Mo to the total of the metal elements in the specific mixed oxide layer is preferably 25 at % or more, and more preferably 30 at % or more, from the viewpoint of maintaining the visibility. On the other hand, the proportion of Mo to the total of the metal elements is preferably 70 at % or less, and more preferably 65 at % or less, from the viewpoint of the optical stability.

The proportion of Nb to the total of the metal elements in the specific mixed oxide layer is preferably 20 at % or more, and more preferably 25 at % or more, from the viewpoint of the optical stability and the visibility. On the other hand, the proportion of Nb to the total of the metal elements is preferably 70 at % or less, and more preferably 60 at % or less, from the viewpoint of the optical stability and the visibility.

The specific mixed oxide layer is preferably amorphous. Being amorphous, it can be produced at a relatively low temperature, and is suitable for use in the case where the transparent substrate includes a resin, since the resin is not damaged by heat.

The specific mixed oxide layer is preferably included as a high refractive index layer in the anti-reflective film, for example, preferably the first dielectric layer 32 in FIGURE.

In the anti-reflective film, the high refractive index layer preferably has a refractive index at a wavelength of 550 nm of 1.8 to 2.5, from the viewpoint of a light transmittance between the transparent substrate and the anti-reflective film.

In addition, the high refractive index layer has an extinction coefficient of preferably 0.005 to 3, and more preferably 0.04 to 0.38. When the extinction coefficient is 0.005 or more, a desired absorption rate can be achieved with an appropriate number of layers. In addition, when the extinction coefficient is 3 or less, it is relatively easy to achieve both the reflection color tone and the transmittance. The extinction coefficient of the high refractive index layer can be adjusted by changing a degree of oxidation of the mixed oxide, for example.

Among the layers in the laminated structure of the anti-reflective film, at least another layer other than the mixed oxide layer is mainly formed of a Si oxide (SiOₓ). The layer mainly formed of a Si oxide means a layer in which the component having the largest content in terms of mass is a Si oxide (SiOₓ). For example, a layer containing a Si oxide (SiOₓ) in a content of 70 mass % or more is preferred. In the case of being combined with the specific mixed oxide layer, the layer mainly formed of a Si oxide (SiOₓ) is included as a low refractive index layer in the anti-reflective film, for example, the second dielectric layer 34 in FIGURE.

When the anti-reflective film includes the layer mainly formed of a Si oxide (SiOₓ), since this layer has a relatively low refractive index, a reflectance reduction effect is high. Note that, SiOₓ may be fully oxidized silicon oxide (SiO₂), but from the viewpoint of improving optical reliability and scratch resistance, SiOₓ is preferably an oxygen-deficient silicon oxide. In addition, for the purpose of improving the reliability, the silicon oxide layer may contain an oxide containing at least one selected from the group consisting of Nb, Ti, Zr, Ta, Al, Sn, W, Mo, and In, and each oxide may have oxygen deficiency.

The anti-reflective film (multilayer film) 30 shown in FIGURE has a two-layer laminated structure in which the first dielectric layer 32 and the second dielectric layer 34 are laminated. The anti-reflective film (multilayer film) in the present embodiment is not limited to this, and may have a laminated structure in which three or more dielectric layers having different refractive indices are laminated. In this case, it is not necessary for all dielectric layers to have different refractive indices. That is, the laminated structure may be a laminated structure in which three or more dielectric layers are laminated such that adjacent layers have different refractive indices.

For example, in the case of a three-layer laminated structure, it can be a three-layer laminated structure including a low refractive index layer, a high refractive index layer, and a low refractive index layer, or a three-layer laminated structure including a high refractive index layer, a low refractive index layer, and a high refractive index layer. In the former case, the two low refractive index layers may have the same refractive index, and in the latter case, the two high refractive index layers may have the same refractive index. In the case of a four-layer laminated structure, it can be a four-layer laminated structure including a low refractive index layer, a high refractive index layer, a low refractive index layer, and a high refractive index layer, or a four-layer laminated structure including a high refractive index layer, a low refractive index layer, a high refractive index layer, and a low refractive index layer. In this case, at least one of the two low refractive index layers and the two high refractive index layers may have the same refractive index. In addition, the anti-reflective film may include a dielectric layer other than the specific mixed oxide layer and the layer mainly formed of a Si oxide (SiOₓ) described above.

Note that, in the present description, the high refractive index layer refers to a layer having a refractive index relatively higher than that of the adjacent layer in the anti-reflective film, and is preferably a layer having a refractive index of 1.8 or more at a wavelength of 550 nm. In addition, the low refractive index layer refers to a layer having a refractive index relatively lower than that of the adjacent layer in the anti-reflective film, and is preferably a layer having a refractive index of 1.6 or less at a wavelength of 550 nm.

The outermost layer in the anti-reflective film is preferably the layer mainly formed of a Si oxide (SiOₓ). When the outermost layer is the layer mainly formed of a Si oxide (SiOₓ) in order to obtain low reflectivity, production is relatively easy. In addition, although the reflectance may increase slightly, for the purpose of improving the reliability, the layer mainly formed of a Si oxide (SiOₓ) may contain an oxide containing at least one selected from the group consisting of Nb, Ti, Zr, Ta, Al, Sn, W, Mo, and In. In order to prevent the increase in reflectance, the content of the metal elements other than Si, excluding oxygen, is preferably 30 at % or less, more preferably 20 at % or less, and still more preferably 15 at % or less. In addition, in the case of forming an antifouling film to be described later on the anti-reflective film 30, it is preferable to form the antifouling film on the layer mainly formed of a Si oxide (SiOₓ) from the viewpoint of bonding properties related to the durability of the antifouling film.

The thickness of the anti-reflective film is preferably 250 nm or less, more preferably 245 nm or less, and still more preferably 240 nm or less, from the viewpoint of improving the productivity. On the other hand, the thickness of the anti-reflective film is preferably 190 nm or more, and more preferably 200 nm or more, from the viewpoint of improving the optical properties.

The number of layers constituting the laminated structure of the anti-reflective film is 2 or more, and preferably 4 or more. On the other hand, the number of layers is preferably 8 or less, and more preferably 6 or less, from the viewpoint of improving the productivity.

The composition of each layer constituting the anti-reflective film can be determined by, for example, X-ray photoelectron spectroscopy (XPS) depth direction composition analysis using argon ion sputtering. In addition, the thickness of each layer is determined by measuring the reflectance of the light at various wavelengths using a spectrophotometer, for example, and performing a simulation using the measurement results.

The anti-reflective film 30 in the present embodiment can be formed on a main surface of a transparent substrate by using a known film-forming method. That is, the dielectric layers constituting the anti-reflective film 30 are formed on the main surface on which the anti-reflective film is to be formed, such as on a transparent substrate or on a barrier layer to be described later, according to the lamination order.

Examples of the known film-forming method include a dry film-forming process such as a CVD method, a sputtering method, or a vacuum deposition method, and a wet film-forming process such as a spraying method or a dipping method. A dry film-forming process is preferred from the viewpoint of easily obtaining a film having an appropriately controlled thickness and quality.

Among the dry film-forming process, a sputtering method is more preferred from the viewpoint of easily obtaining a film having an appropriately controlled thickness and quality. Examples of the sputtering method include methods such as magnetron sputtering, pulse sputtering, AC sputtering, and digital sputtering.

For example, the magnetron sputtering method is a method in which a magnet is placed on a back surface of a base dielectric material to generate a magnetic field, and gas ion atoms collide with the surface of the dielectric material and are ejected, to form a sputtering film having a thickness of several nm, and a film of a dielectric that is an oxide or a nitride of the dielectric material can be formed.

In addition, for example, the digital sputtering method is a method of forming a metal oxide thin film by repeating steps of first forming a metal ultra-thin film by sputtering, and then oxidizing the film by irradiation with oxygen plasma, oxygen ions, or oxygen radicals in the same chamber, unlike a general magnetron sputtering method. In this case, since film-forming molecules are metals when deposited on a substrate, it is presumed to be more ductile than a case of depositing a metal oxide. Therefore, it is thought that even when the energy is the same, rearrangement of the film-forming molecules is likely to occur, and as a result, a dense and smooth film can be formed.

In the embodiment of the present invention, the anti-reflective film may be provided on at least one main surface of the transparent substrate, or may be provided on both main surfaces of the transparent substrate, if necessary.

### (Physical Properties of Anti-Reflective Film-Attached Transparent Substrate)

### (Indentation Hardness)

In the anti-reflective film-attached transparent substrate, an indentation hardness on the main surface having the anti-reflective film is preferably 5.6 GPa or more. When the indentation hardness is the above value or more, it is possible to obtain an anti-reflective film-attached transparent substrate including an anti-reflective film excellent in strength. The indentation hardness is not particularly limited in upper limit, and may be, for example, 8.5 GPa or less. The indentation hardness is a hardness measured based on ISO14577 on the main surface having the anti-reflective film.

### (Indentation Elastic Modulus)

In the anti-reflective film-attached transparent substrate, an indentation elastic modulus on the main surface having the anti-reflective film is preferably 75 GPa or more, and more preferably 76 GPa or more. When the indentation hardness is the above value or more, it is possible to obtain an anti-reflective film-attached transparent substrate including an anti-reflective film excellent in strength. The indentation elastic modulus is not particularly limited in upper limit, and may be, for example, 86 GPa or less. The indentation elastic modulus is an elastic modulus measured based on ISO14577 on the main surface having the anti-reflective film.

### (Luminous Transmittance (Y))

A luminous transmittance (Y) of the anti-reflective film-attached transparent substrate can be adjusted depending on the application or purpose, and is not particularly limited, and may be, for example, 40% to 90%, or 50% to 80%. In the case where the luminous transmittance (Y) is within the above range, the anti-reflective film-attached transparent substrate has an appropriate light absorption ability. Therefore, in the case where the anti-reflective film-attached transparent substrate is used as a cover glass of an image display device, the light reflection can be prevented. That is, when the anti-reflective film has an appropriate light absorption ability, the anti-reflective film appropriately absorbs the light reflected on the transparent substrate side than the anti-reflective film, so that the reflection can be more easily reduced, and the bright contrast of the image display device is improved. In the case where the anti-reflective film-attached transparent substrate is used as a cover glass of a display, for example, a preferred luminous transmittance (Y) may vary depending on the environment. For example, in a relatively dark interior of an automobile, for example, a luminous transmittance (Y) of 70% or more may be suitable. On the other hand, in an environment where bright sunlight is present, it is preferable to set the luminous transmittance (Y) to about 50% (for example, about 40% to 60%), which makes it possible to prevent external light reflection and improve the visibility.

The luminous transmittance (Y) can be measured according to the method specified in JIS Z 8701 (1999), as to be described later in Examples.

### (b* Value of Transmission Color Under D65 Light Source)

In the anti-reflective film-attached transparent substrate, a b* value of a transmission color under a D65 light source is preferably 9 or less. When the b* value is within the above range, the transmitted light is prevented from being yellowish, so that it is suitable for use as a cover glass of an image display device. The b* value is more preferably 8 or less. In addition, the b* value is preferably −4 or more, and more preferably −3 or more. The b* value is preferably within the above range since the transmitted light is colorless or nearly colorless and the transmitted light is not hindered.

Note that, the b* value of a transmission color under a D65 light source can be measured according to the method specified in JIS Z 8729 (2004), as to be described later in Examples.

In the case where the luminous transmittance (Y) of the anti-reflective film-attached transparent substrate is 40% or more and 60% or less, the b* value of a transmission color under a D65 light source is preferably 9 or less, and more preferably 8 or less, from the same viewpoint as above. In addition, in the case where the luminous transmittance (Y) is 40% or more and 60% or less, the b* value is preferably −3 or more, and more preferably −2 or more.

In the case where the luminous transmittance (Y) of the anti-reflective film-attached transparent substrate is more than 60% and 90% or less, the b* value of a transmission color under a D65 light source is preferably 6 or less, and more preferably 5 or less. In addition, in the case where the luminous transmittance (Y) is more than 60% and 90% or less, the b* value is preferably −3 or more, and more preferably −2 or more. In the case where the luminous transmittance (Y) is more than 60% and 90% or less, the degree of oxidation of the mixed oxide layer is relatively high, and the optical absorption of the mixed oxide layer is relatively small. In the case where the optical absorption of the mixed oxide layer is relatively small, an optical wavelength dependency of the layer is also likely to be reduced. Accordingly, in the case where the luminous transmittance (Y) of the anti-reflective film-attached transparent substrate is more than 60% and 90% or less, the b* value is easily set to 6 or less, and the transmitted light is more easily prevented from being yellowish.

In the anti-reflective film-attached transparent substrate, an a* value of a transmission color under a D65 light source is preferably 3 or less. The a* value is more preferably 1.5 or less. In addition, the a* value is preferably −3 or more, and more preferably −1.5 or more. The a* value is preferably within the above range since the transmission color is colorless or nearly colorless and the transmitted light is not hindered.

Note that, the a* value of a transmission color under a D65 light source can be measured according to the method specified in JIS Z 8729 (2004), as to be described later in Examples.

### (Luminous Reflectance SCI Y)

In the anti-reflective film-attached transparent substrate according to the present embodiment, a luminous reflectance (SCI Y) on the outermost surface of the anti-reflective film, that is, a luminous reflectance (SCI Y) on the main surface having the anti-reflective film, is preferably 0.8% or less. When the luminous reflectance (SCI Y) is within the above range, in the case where the anti-reflective film-attached transparent substrate is used as a cover glass of an image display device, an effect of preventing glare of an external light on a screen is increased. The luminous reflectance (SCI Y) is more preferably 0.7% or less, and still more preferably 0.6% or less.

The luminous reflectance (SCI Y) can be measured according to the method specified in JIS Z 8722 (2009), as to be described later in Examples.

### (Other Configurations of Anti-Reflective Film-Attached Transparent Substrate)

### (Transparent Substrate)

In the present embodiment, the transparent substrate having two main surfaces (hereinafter, also simply referred to as the transparent substrate) preferably has a refractive index of 1.4 or more and 1.7 or less. When the refractive index of the transparent substrate is within the above range, reflection at an adhesion surface can be sufficiently prevented in the case of optically adhering a display, a touch panel, or the like. The refractive index is more preferably 1.45 or more, and still more preferably 1.47 or more. In addition, the refractive index is more preferably 1.65 or less, and still more preferably 1.6 or less.

The transparent substrate may include at least one of a glass and a resin. The transparent substrate may include both a glass and a resin. In addition, a diffusion layer to be described later can be easily formed by attaching a laminate formed of a resin substrate and an anti-glare layer, to be described later, on a glass substrate. In the anti-reflective film-attached transparent substrate in which the diffusion layer is formed by this method, the transparent substrate includes both a glass and a resin.

In the case where the transparent substrate includes a glass, the kind of the glass is not particularly limited, and glasses having various compositions can be used. Among them, the glass preferably contains sodium and preferably has a composition that allows molding and strengthening by a chemical strengthening treatment. Specific examples such a glass include an aluminosilicate glass, a soda lime glass, a borosilicate glass, a lead glass, an alkali barium glass, an aluminoborosilicate glass, an alkali-free glass, and a quartz glass.

Note that, in the present description, in the case where the transparent substrate includes a glass, the transparent substrate is also called a glass substrate.

The thickness of the glass substrate is not particularly limited, and in the case of subjecting the glass to a chemical strengthening treatment, for example, the thickness is preferably 5 mm or less, more preferably 3 mm or less, and still more preferably 1.5 mm or less, in order to effectively perform the chemical strengthening. In addition, the thickness may be, for example, 0.2 mm or more.

The glass substrate is preferably a chemically strengthened glass obtained by chemical strengthening. Accordingly, the strength of the anti-reflective film-attached transparent substrate is increased. Note that, in the case where the glass substrate is subjected to an anti-glare treatment to be described later, the chemical strengthening is preferably performed after the anti-glare treatment and before forming the anti-reflective film (multilayer film).

In the case where the transparent substrate includes a resin, the kind of the resin is not particularly limited, and resins having various compositions can be used. Among them, the resin is preferably a thermoplastic resin or a thermosetting resin. Examples thereof include a polyvinyl chloride resin, a polyethylene resin, a polypropylene resin, a polystyrene resin, a polyvinyl acetate resin, a polyester resin, a polyurethane resin, a cellulose-based resin, an acrylic resin, an AS (acrylonitrile-styrene) resin, an ABS (acrylonitrile-butadiene-styrene) resin, a fluorine-based resin, a thermoplastic elastomer, a polyamide resin, a polyimide resin, a polyacetal resin, a polycarbonate resin, a modified polyphenylene ether resin, a polyethylene terephthalate resin, a polybutylene terephthalate resin, a polylactic acid-based resin, a cyclic polyolefin resin, and a polyphenylene sulfide resin. Among them, a cellulose-based resin is preferred, and examples thereof include a triacetyl cellulose resin, a polycarbonate resin, and a polyethylene terephthalate resin. These resins may be used alone or in combination of two or more kinds thereof.

The resin particularly preferably includes at least one resin selected from polyethylene terephthalate, a polycarbonate, acrylic, silicone, and triacetyl cellulose, from the viewpoint of excellent visible light transparency and easy availability.

Note that, in the present description, in the case where the transparent substrate includes a resin, the transparent substrate is also called a resin substrate.

The resin substrate is preferably in the form of a film. In the case where the resin substrate is in the form of a film, that is, when it is a resin film, the thickness is not particularly limited, and for example, is preferably 20 μm to 300 μm, and more preferably 30 μm to 130 μm.

Examples of the case where the transparent substrate includes both a glass and a resin include a case of a composite substrate in which a glass substrate and a resin substrate are laminated. More specifically, the transparent substrate may be, for example, in a form in which the above resin substrate is provided on the above glass substrate.

### (Diffusion Layer)

The anti-reflective film-attached transparent substrate may include a diffusion layer. The diffusion layer is provided, for example, between the anti-reflective film and the transparent substrate. The diffusion layer means a layer having a function of diffusing a specularly reflected light and reducing the glare and the reflection, and examples thereof include an anti-glare layer imparted with the function of diffusing the specularly reflected light (anti-glare properties) in the hard coat layer. When the anti-reflective film-attached transparent substrate has a configuration including a diffusion layer, both effects of preventing the glare by the anti-reflective film and preventing the glare by the diffusion layer can be obtained. In addition, when the anti-reflective film is further provided on the diffusion layer, reflection of the incident light is prevented, so that the screen can be prevented from appearing whitish due to the light diffused by the diffusion layer.

The anti-glare layer has irregularities on one surface thereof, and thereby causes external scattering or internal scattering, increasing the haze value and imparting anti-glare properties. The anti-glare layer is formed of, for example, an anti-glare layer composition obtained by dispersing, in a solution in which a polymer resin as a binder is dissolved, a particulate substance having at least anti-glare properties in itself. The anti-glare layer can be formed, for example, by coating one main surface of the transparent substrate with the anti-glare layer composition.

Examples of the particulate substance having anti-glare properties include inorganic fine particles such as silica, clay, talc, calcium carbonate, calcium sulfate, barium sulfate, aluminum silicate, titanium oxide, synthetic zeolite, alumina, and smectite, and organic fine particles including a styrene resin, a urethane resin, a benzoguanamine resin, a silicone resin, an acrylic resin, a melamine resin, or the like.

In addition, as the polymer resin as a binder for the hard coat layer or the anti-glare layer, for example, polymer resins such as a polyester-based resin, an acrylic resin, an acrylic urethane-based resin, a polyester acrylate-based resin, a polyurethane-based acrylate resin, an epoxy acrylate-based resin, and a urethane-based resin can be used.

In the case where the anti-reflective film-attached transparent substrate includes a diffusion layer, the diffusion layer may be formed directly on the transparent substrate, or a laminate formed of a resin substrate and an anti-glare layer may be prepared in advance and then attached to a glass substrate or the like to obtain a configuration in which a diffusion layer is provided on a composite substrate of a glass substrate and a resin substrate. Such a laminate is preferably one in which a diffusion layer is formed on a film-like resin substrate. According to this method, the diffusion layer can be formed more easily.

Specific examples of the laminate formed of a resin substrate and an anti-glare layer include an anti-glare PET film and an anti-glare TAC film. Examples of the anti-glare PET film include trade name: BHC-III and EHC-30a manufactured by Higashiyama Film Co., Ltd., and those manufactured by REIKO Co., Ltd. As the anti-glare TAC film, an anti-glare TAC film (trade name: VZ50 manufactured by TOPPAN TOMOEGAWA Optical Films Co., Ltd.) or the like is used.

Alternatively, the diffusion layer may be formed on the surface layer of the transparent substrate itself by subjecting the transparent substrate to a surface treatment.

For example, in the case of using a glass substrate, a method of subjecting a main surface of a glass to a surface treatment to form desired irregularities can be used.

Specifically, a method of chemically treating the main surface of the glass substrate, for example, a method of applying a frost treatment, can be used. The frost treatment can be performed, for example, by immersing a glass substrate to be treated in a mixed solution containing hydrogen fluoride and ammonium fluoride, and subjecting the immersed surface to a chemical surface treatment.

In addition to chemical treatment methods such as a frost treatment, for example, a method by a physical treatment can also be used including a so-called sandblast treatment in which a crystalline silicon dioxide powder, a silicon carbide powder, or the like is blown onto the surface of the glass substrate with pressurized air, and polishing with a brush to which a crystalline silicon dioxide powder, a silicon carbide powder or the like adheres is moistened with water.

### (Barrier Layer)

The anti-reflective film-attached transparent substrate may include a barrier layer between the transparent substrate and the anti-reflective film. In the case where the transparent substrate includes a resin substrate, such as in the case of forming the diffusion layer by the method of attaching the laminate formed of a resin substrate and an anti-glare layer to a glass substrate, a barrier layer may be provided between the transparent substrate (resin substrate) and the anti-reflective film. The barrier layer may be preferably provided between the transparent substrate and the anti-reflective film, since there are advantages that influences of moisture and oxygen that try to penetrate the anti-reflective film from the resin substrate can be prevented and optical properties are less likely to change. In addition, in the case where the transparent substrate includes a glass substrate, when the barrier layer is provided between the transparent substrate (glass substrate) and the anti-reflective film, alkali metal components and the like are prevented from diffusing into the anti-reflective film and the change in optical properties can be prevented. Therefore, in the case where the transparent substrate includes a glass substrate, the barrier layer may be provided between the transparent substrate and the anti-reflective film.

Examples of the barrier layer include a metal nitride film and a metal oxide film, specifically, a SiNₓ film and a SiOₓ film. From the viewpoint of more effectively preventing the change in optical properties, a SiNₓ film is more preferred. That is, the barrier layer preferably includes a layer mainly formed of at least one of SiNₓ and SiOₓ, and more preferably includes a layer mainly formed of SiNₓ. The layer mainly formed of at least one of SiNₓ and SiOₓ means a layer in which a component having the largest content in terms of mass is at least one of SiNₓ and SiOₓ, and is preferably, for example, a layer in which the content of at least one of SiNₓ and SiOₓ is 70 mass % or more.

From the viewpoint of preventing moisture from penetrating the anti-reflective film, the thickness of the barrier layer is preferably 2 nm or more, more preferably 4 nm or more, and particularly preferably 8 nm or more. On the other hand, from the viewpoint of preventing an increase in reflectance of the anti-reflective film-attached transparent substrate, the thickness is preferably 50 nm or less.

The barrier layer can be formed by using, for example, a known film-forming method such as a sputtering method, a vacuum deposition method, or a coating method.

### (Antifouling Film)

The anti-reflective film-attached transparent substrate according to the present embodiment may further include an antifouling film (also referred to as an “anti finger print (AFP) film”) on the anti-reflective film, from the viewpoint of protecting the outermost surface of the anti-reflective film. The antifouling film can be formed of, for example, a fluorine-containing organosilicon compound. The fluorine-containing organosilicon compound is not particularly limited as long as it can impart an antifouling property, water repellency, and oil repellency, and examples thereof include a fluorine-containing organosilicon compound having one or more groups selected from the group consisting of a polyfluoropolyether group, a polyfluoroalkylene group, and a polyfluoroalkyl group. Note that, the polyfluoropolyether group is a divalent group having a structure in which polyfluoroalkylene groups and etheric oxygen atoms are alternately bonded.

As a commercially available fluorine-containing organosilicon compound having one or more groups selected from the group consisting of a polyfluoropolyether group, a polyfluoroalkylene group, and a polyfluoroalkyl group, KP-801 (trade name, manufactured by Shin-Etsu Chemical Co., Ltd.), KY178 (trade name, manufactured by Shin-Etsu Chemical Co., Ltd.), KY-130 (trade name, manufactured by Shin-Etsu Chemical Co., Ltd.), KY-185 (trade name, manufactured by Shin-Etsu Chemical Co., Ltd.), and Optool (registered trademark) DSX and Optool AES (trade name, all manufactured by Daikin Industries, Ltd.) can be preferably used.

In the case where the anti-reflective film-attached transparent substrate according to the present embodiment includes an antifouling film, the antifouling film is provided on the anti-reflective film. In the case where the anti-reflective film is provided on both main surfaces of the transparent substrate, the antifouling film can be formed on both the anti-reflective films, or the antifouling film may be laminated on only one of the main surfaces. This is because the antifouling film only needs to be provided at places where there is a possibility of contact with human hands, and the configuration can be selected according to the application.

### (Method for Producing Anti-Reflective Film-Attached Transparent Substrate)

A method for producing an anti-reflective film-attached transparent substrate according to the present embodiment is not particularly limited, and for example, the anti-reflective film-attached transparent substrate can be produced by a method including forming layers constituting an anti-reflective film on a main surface of a transparent substrate. If necessary, the method may further include forming a layer such as a diffusion layer, a barrier layer, or an antifouling film. The method for forming each layer is as described above.

### (Application)

The anti-reflective film-attached transparent substrate according to the present embodiment is suitably used as a surface material of various image display devices such as a liquid crystal display, an organic EL display, and an electronic paper display. The anti-reflective film-attached transparent substrate is suitable as a cover glass of an image display device, particularly a cover glass or a cover member of an image display device mounted on a vehicle such as an image display device for a navigation system mounted on a vehicle.

### (Image Display Device)

An image display device according to one embodiment of the present invention includes the above anti-reflective film-attached transparent substrate. Examples of the image display device include an embodiment including the above anti-reflective film-attached transparent substrate on various image display devices such as a liquid crystal display, an organic EL display, and an electronic paper display.

### EXAMPLES

Hereinafter, the present invention is described in detail with reference to Examples, but the present invention is not limited thereto. Example 1 and Example 2 are Inventive Examples, and Example 3 and Example 4 are Comparative Examples.

### Example 1 to Example 4

A barrier layer, an anti-reflective film, and an antifouling layer were formed in this order on a transparent substrate (on the diffusion layer in the case of a diffusion layer-attached transparent substrate), to obtain anti-reflective film-attached transparent substrates in Example 1 to Example 4. The anti-reflective film was formed by laminating a low refractive index layer and a high refractive index layer in a total of four in the following configuration, as shown in Table 1. Note that, mixed oxide layers 1 to 4 shown in Table 1 are mixed oxide layers having metal element contents as shown in Table 2.

That is, the anti-reflective film-attached transparent substrate in each example has a configuration in which the following layers were laminated in order from the transparent substrate to the antifouling layer. In the case where a diffusion layer-attached transparent substrate is used as the transparent substrate, a diffusion layer is further provided between the transparent substrate and the barrier layer. In addition, the thickness of each layer below is determined by measuring the reflectance of the light at various wavelengths using a spectrophotometer, and performing a simulation using the measurement results.

### Configurations of Anti-Reflective Film-Attached Transparent Substrates in Example 1 to Example 4

Transparent substrate/barrier layer (4 nm)/high refractive index layer (6 nm)/low refractive index layer (30 nm)/high refractive index layer (116 nm)/low refractive index layer (86 nm)/antifouling layer (4 nm)

The transparent substrates used in each example were of the following four types. As transparent substrates 1 to 3, two types of samples were prepared by adjusting the degree of oxidation of the high refractive index layer such that the luminous transmittance (Y) of the anti-reflective film-attached transparent substrate was 55% and 75%, and as a transparent substrate 4, a sample was prepared in which the luminous transmittance (Y) of the anti-reflective film-attached transparent substrate was 75%. A total of seven types of samples were prepared for each example. Note that, the transparent substrates 1 and 2 are each a diffusion layer-attached transparent substrate including a diffusion layer on a transparent substrate.
Transparent substrate 1: anti-glare PET film (manufactured by REIKO Co., Ltd., substrate thickness: 50 μm, haze: 60%)
Transparent substrate 2: anti-glare TAC film (trade name: VZ50 manufactured by TOPPAN TOMOEGAWA Optical Films Co., Ltd., substrate thickness: 40 μm, haze: 30%)
Transparent substrate 3: TAC film (manufactured by Konica Minolta, Inc., thickness: 40 μm)
Transparent substrate 4: glass substrate (Dragontrail (Registered trademark) manufactured by AGC Inc., thickness: 1.1 mm)

The film-forming conditions for each layer of the barrier layer, the anti-reflective film, and the antifouling layer were as follows.

### (Barrier Layer)

As the barrier layer, a layer made of a silicon nitride (SiNₓ) having a predetermined thickness was formed by DC magnetron sputtering using a silicon target in a digital sputtering method while maintaining the pressure at 0.2 Pa with an argon gas. Note that, after the metal film was formed, nitridation was performed using nitrogen plasma to form a layer made of a nitride.

### (Low Refractive Index Layer)

### (SiO₂ Layer)

A layer made of a silicon oxide [silica (SiO₂)] having a predetermined thickness was formed by DC magnetron sputtering using a silicon target in a digital sputtering method while maintaining the pressure at 0.2 Pa with an argon gas. Note that, after the metal film was formed, oxidation was performed using oxygen plasma to form a layer made of an oxide.

### (High Refractive Index Layer)

### (Mixed Oxide Layer 1)

A mixed oxide layer 1 having a predetermined thickness was formed by DC magnetron sputtering using a target made by mixing and sintering niobium, molybdenum, and tungsten in a mass ratio of 24:30:46 in a digital sputtering method while maintaining the pressure at 0.2 Pa with an argon gas. Note that, after the metal film was formed, oxidation was performed using oxygen plasma to form a layer made of an oxide. In addition, the oxygen concentration was adjusted according to the type of the transparent substrate and the target luminous transmittance, and the degree of oxidation of the mixed oxide layer was adjusted such that the luminous transmittance (Y) of the obtained anti-reflective film-attached transparent substrate was 55% or 75%.

### (Mixed Oxide Layer 2)

A mixed oxide layer 2 was formed in the same manner as the mixed oxide layer 1 except that a target made by mixing and sintering niobium, molybdenum, and tungsten in a mass ratio of 45:30:25 was used.

### (Mixed Oxide Layer 3)

A mixed oxide layer 3 was formed in the same manner as the mixed oxide layer 1 except that a target made by mixing and sintering niobium, molybdenum, and tungsten in a mass ratio of 24:56:20 was used.

### (Mixed Oxide Layer 4)

A mixed oxide layer 4 was formed in the same manner as the mixed oxide layer 1 except that a target made by mixing and sintering niobium and molybdenum in a mass ratio of 40:60 was used.

### (Antifouling Layer)

KY-185 (trade name, manufactured by Shin-Etsu Chemical Co., Ltd.) as a fluorine-containing organosilicon compound was charged into a metal crucible (evaporation source) and heated to evaporate at 230° C. to 350° C. The evaporated particles evaporated and diffused into a vacuum chamber in which the substrate was installed, and adhered on the surface of the substrate. A 4-nm thick antifouling layer was formed while a vapor deposition rate was monitored by controlling with a crystal oscillator.

The samples in each example were subjected to measurement and evaluation as follows. The results are shown in Table 1.

### (Indentation Hardness and Indentation Elastic Modulus)

The indentation hardness and the indentation elastic modulus were measured based on ISO14577. Among the samples in each example, using a sample using the transparent substrate 4, nanoindentation measurement was performed with a load of 1 mN to measure the indentation hardness and the indentation elastic modulus on the main surface having the anti-reflective film.

### (Optical Properties)

### (Luminous Transmittance: Y)

In the prepared anti-reflective film-attached transparent substrate, the luminous transmittance (Y) on the outermost surface of the anti-reflective film was measured according to the method specified in JIS Z 8701 (1999). Specifically, of two main surfaces of the transparent substrate, a black tape was attached to the other main surface, which was not the main surface facing the anti-reflective film, to eliminate back surface reflection. In this state, the spectral transmittance was measured using a spectrophotometer (trade name: SolidSpec-3700 manufactured by Shimadzu Corporation), and the luminous transmittance (a stimulus value Y specified in JIS Z 8701 (1999)) was obtained by calculation.

### (Transmission Color (a* Value and b* Value) of Anti-Reflective Film-Attached Transparent Substrate Under D65 Light Source)

The color index (a* value and b* value) specified in JIS Z 8729 (2004) was determined based on a transmission spectrum obtained by measuring the above spectral transmittance. As the light source, a D65 light source was used.

### (Luminous Reflectance: SCI Y)

In the prepared anti-reflective film-attached transparent substrate, the luminous reflectance (SCI Y) on the outermost surface of the anti-reflective film was measured according to the method specified in JIS Z 8722 (2009). Specifically, of two main surfaces of the transparent substrate, a black tape was attached to the other main surface, which was not the main surface facing the anti-reflective film, to eliminate back surface reflection. In this state, the luminous reflectance (SCI Y) of the total reflected light was measured using a spectrophotometer (trade name: CM-26d manufactured by Konica Minolta, Inc.). The light source was a D65 light source.

TABLE 1

| | | | Example 1 | | | |
|---|---|---|---|---|---|---|
| Composition of | Low refractive index layer | | SiO₂ | | | |
| anti-reflective | High refractive index layer | | Mixed oxide layer 1 | | | |
| film | | | | | | |
| Nanoindentation | Indentation hardness (GPa) | | 5.6 | | | |
| | Indentation elastic | | 76 | | | |
| | modulus (GPa) | | | | | |
| Optical | Luminous | Substrate | Transparent | Transparent | Transparent | Transparent |
| properties | transmittance | (haze (%)) | substrate 1 | substrate 2 | substrate 3 | substrate 4 |
| | (Y) (%) | | (60) | (30) | (0) | (0) |
| | 75 | Transmission a* | 0.43 | 0.5 | 0.42 | 0.32 |
| | | Transmission b* | 0.41 | 0.79 | 0.77 | 0.18 |
| | | SCI-Y (%) | 0.58 | 0.25 | 0.23 | 0.25 |
| | 55 | Transmission a* | 0.8 | 0.98 | 0.96 | — |
| | | Transmission b* | 3.77 | 4.52 | 4.5 | — |
| | | SCI-Y (%) | 0.41 | 0.19 | 0.16 | — |
| | | | Example 2 | | | |
| Composition of | Low refractive index layer | | SiO₂ | | | |
| anti-reflective | High refractive index layer | | Mixed oxide layer 2 | | | |
| film | | | | | | |
| Nanoindentation | Indentation hardness (GPa) | | 5.6 | | | |
| | Indentation elastic | | 77 | | | |
| | modulus (GPa) | | | | | |
| Optical | Luminous | Substrate | Transparent | Transparent | Transparent | Transparent |
| properties | transmittance | (haze (%)) | substrate 1 | substrate 2 | substrate 3 | substrate 4 |
| | (Y) (%) | | (60) | (30) | (0) | (0) |
| | 75 | Transmission a* | 0.53 | 0.6 | 0.56 | 0.51 |
| | | Transmission b* | 2.98 | 3.16 | 3.71 | 2.35 |
| | | SCI-Y (%) | 0.71 | 0.2 | 0.87 | 0.21 |
| | 55 | Transmission a* | 1.08 | 1.35 | 1.33 | — |
| | | Transmission b* | 7.78 | 8.49 | 8.54 | — |
| | | SCI-Y (%) | 0.66 | 0.16 | 0.51 | — |
| | | | Example 3 | | | |
| Composition of | Low refractive index layer | | SiO₂ | | | |
| anti-reflective | High refractive index layer | | Mixed oxide layer 3 | | | |
| film | | | | | | |
| Nanoindentation | Indentation hardness (GPa) | | 5 | | | |
| | Indentation elastic | | 74 | | | |
| | modulus (GPa) | | | | | |
| Optical | Luminous | Substrate | Transparent | Transparent | Transparent | Transparent |
| properties | transmittance | (haze (%)) | substrate 1 | substrate 2 | substrate 3 | substrate 4 |
| | (Y) (%) | | (60) | (30) | (0) | (0) |
| | 75 | Transmission a* | −0.23 | −0.19 | −0.24 | −0.36 |
| | | Transmission b* | −0.83 | −0.96 | −0.87 | −1.02 |
| | | SCI-Y (%) | 0.67 | 0.29 | 0.29 | 0.28 |
| | 55 | Transmission a* | 0.5 | 0.61 | 0.55 | — |
| | | Transmission b* | 2.1 | 2.99 | 2.73 | — |
| | | SCI-Y (%) | 0.38 | 0.19 | 0.17 | — |
| | | | Example 4 | | | |
| Composition of | Low refractive index layer | | SiO₂ | | | |
| anti-reflective | High refractive index layer | | Mixed oxide layer 4 | | | |
| film | | | | | | |
| Nanoindentation | Indentation hardness (GPa) | | 5.5 | | | |
| | Indentation elastic | | 74 | | | |
| | modulus (GPa) | | | | | |
| Optical | Luminous | Substrate | Transparent | Transparent | Transparent | Transparent |
| properties | transmittance | (haze (%)) | substrate 1 | substrate 2 | substrate 3 | substrate 4 |
| | (Y) (%) | | (60) | (30) | (0) | (0) |
| | 75 | Transmission a* | 0.05 | 0.09 | 0.06 | −0.02 |
| | | Transmission b* | 0.71 | 0.96 | 1.19 | 0.52 |
| | | SCI-Y (%) | 0.67 | 0.25 | 0.25 | 0.24 |
| | 55 | Transmission a* | 0.72 | 1 | 0.91 | — |
| | | Transmission b* | 4.4 | 5.26 | 5.56 | — |
| | | SCI-Y (%) | 0.79 | 0.31 | 0.3 | — |

TABLE 2

| | Composition (wt %) | | | Composition (at %) | | | |
|---|---|---|---|---|---|---|---|
| | Nb | Mo | W | Nb | Mo | W | Mo/(Nb + Mo) |
| Mixed oxide | 24 | 30 | 46 | 31.5 | 38.1 | 30.5 | 0.55 |
| layer 1 | | | | | | | |
| Mixed oxide | 45 | 30 | 25 | 51.9 | 33.5 | 14.6 | 0.39 |
| layer 2 | | | | | | | |
| Mixed oxide | 24 | 56 | 20 | 27.2 | 61.4 | 11.4 | 0.69 |
| layer 3 | | | | | | | |
| Mixed oxide | 40 | 60 | 0 | 40.7 | 59.3 | 0 | 0.59 |
| layer 4 | | | | | | | |

As seen from the results in Table 1 and Table 2, in Example 1 and Example 2 as an anti-reflective film-attached transparent substrate including an anti-reflective film including the specific mixed oxide layer described above, the indentation hardness and the indentation elastic modulus were both greater than those in Example 3 and Example 4, and the strength of the anti-reflective film was excellent. In addition, when the anti-reflective film-attached transparent substrate in each example was stored for a long time under high temperature conditions and high temperature and high humidity conditions, the anti-reflective film-attached transparent substrates in Example 1 and Example 2 had a change in optical properties after being stored smaller than that of the anti-reflective film-attached transparent substrates in Example 3 and Example 4, and were excellent in optical stability. In addition, in Example 1 and Example 2, the b* value of the transmission color was within a preferred range of 10 or less, and the visibility was also excellent during use in a display.

As described above, the following matters are disclosed in the present description.
1. An anti-reflective film-attached transparent substrate including:
a transparent substrate having two main surfaces; and
an anti-reflective film on one main surface of the transparent substrate, in which
the anti-reflective film has a laminated structure in which at least two layers having different refractive indices are laminated,
at least one layer among layers in the laminated structure is mainly formed of a Si oxide,
at least another layer among the layers in the laminated structure is a mixed oxide layer mainly formed of a mixed oxide containing Mo and Nb,
the mixed oxide layer contains an oxide of at least one high hardness metal element selected from the group consisting of W, Cr, Mn, Ni, Zr, Ta, and Be,
a proportion of Mo to a total of Mo and Nb in the mixed oxide layer is 60 at % or less, and
a proportion of a total of the high hardness metal element to a total of metal elements in the mixed oxide layer is 12 at % or more.
2. The anti-reflective film-attached transparent substrate according to the above 1, having a luminous transmittance (Y) of 40% to 90%.
3. The anti-reflective film-attached transparent substrate according to the above 1 or 2, having a luminous transmittance (Y) of 40% or more and 60% or less and b* of a transmission color under a D65 light source of 9 or less.
4. The anti-reflective film-attached transparent substrate according to the above 1 or 2, having a luminous transmittance (Y) of more than 60% and 90% or less and b* of a transmission color under a D65 light source of 6 or less.
5. The anti-reflective film-attached transparent substrate according to any one of the above 1 to 4, in which an indentation hardness on the main surface having the anti-reflective film is 5.6 GPa or more.
6. The anti-reflective film-attached transparent substrate according to any one of the above 1 to 5, in which an indentation elastic modulus on the main surface having the anti-reflective film is 75 GPa or more.
7. The anti-reflective film-attached transparent substrate according to any one of the above 1 to 6, in which a luminous reflectance (SCI Y) on the main surface having the anti-reflective film is 0.8% or less.
8. The anti-reflective film-attached transparent substrate according to any one of the above 1 to 7, in which the anti-reflective film has a thickness of 250 nm or less.
9. The anti-reflective film-attached transparent substrate according to any one of the above 1 to 8, in which the number of the layers constituting the laminated structure is 8 or less.
10. The anti-reflective film-attached transparent substrate according to any one of the above 1 to 9, including a barrier layer between the transparent substrate and the anti-reflective film, in which the barrier layer includes a layer mainly formed of at least one of SiNₓ and SiOₓ.
11. An image display device including the anti-reflective film-attached transparent substrate according to any one of the above 1 to 10.

Although various embodiments have been described above with reference to the drawings, it is needless to say that the present invention is not limited to such examples. It is obvious for a person skilled in the art that various modifications and variations can be made within the category described in the scope of claims and it is understood that such modifications and variations naturally belong to the technical scope of the present invention. Further, the components described in the above embodiment may be combined in any manner without departing from the spirit of the invention.

Note that, the present application is based on a Japanese patent application (Japanese Patent Application No. 2022-177400) filed on Nov. 4, 2022, a Japanese patent application (Japanese Patent Application No. 2022-064751) filed on Apr. 8, 2022, a Japanese patent application (Japanese Patent Application No. 2022-064752) filed on Apr. 8, 2022, and a Japanese patent application (Japanese Patent Application No. 2022-112709) filed on Jul. 13, 2022, contents of which are incorporated herein by reference.

### REFERENCE SIGNS LIST

10 transparent substrate
30 anti-reflective film
32, 34 dielectric layer

1. An anti-reflective film-attached transparent substrate comprising:
a transparent substrate comprising two main surfaces; and
an anti-reflective film on one main surface of the transparent substrate,
wherein the anti-reflective film has a laminated structure in which at least two layers having different refractive indices are laminated,
at least one layer among layers in the laminated structure is mainly formed of a Si oxide,
at least another layer among the layers in the laminated structure is a mixed oxide layer mainly formed of a mixed oxide containing Mo and Nb,
the mixed oxide layer comprises an oxide of at least one high hardness metal element selected from the group consisting of W, Cr, Mn, Ni, Zr, Ta, and Be,
a proportion of Mo to a total of Mo and Nb in the mixed oxide layer is 60 at % or less, and
a proportion of a total of the high hardness metal element to a total of metal elements in the mixed oxide layer is 12 at % or more.

2. The anti-reflective film-attached transparent substrate according to claim 1, having a luminous transmittance (Y) of 40% to 90%.

3. The anti-reflective film-attached transparent substrate according to claim 1, having a luminous transmittance (Y) of 40% or more and 60% or less and b* of a transmission color under a D65 light source of 9 or less.

4. The anti-reflective film-attached transparent substrate according to claim 1, having a luminous transmittance (Y) of more than 60% and 90% or less and b* of a transmission color under a D65 light source of 6 or less.

5. The anti-reflective film-attached transparent substrate according to claim 1, wherein an indentation hardness on the main surface having the anti-reflective film is 5.6 GPa or more.

6. The anti-reflective film-attached transparent substrate according to claim 1, wherein an indentation elastic modulus on the main surface having the anti-reflective film is 75 GPa or more.

7. The anti-reflective film-attached transparent substrate according to claim 1, wherein a luminous reflectance (SCI Y) on the main surface having the anti-reflective film is 0.8% or less.

8. The anti-reflective film-attached transparent substrate according to claim 1, wherein the anti-reflective film has a thickness of 250 nm or less.

9. The anti-reflective film-attached transparent substrate according to claim 1, wherein the number of the layers constituting the laminated structure is 8 or less.

10. The anti-reflective film-attached transparent substrate according to claim 1, comprising a barrier layer between the transparent substrate and the anti-reflective film,
wherein the barrier layer comprises a layer mainly formed of at least one of SiNₓ and SiOₓ.

11. An image display device comprising the anti-reflective film-attached transparent substrate according to claim 1.
